(19) United States
(12) Patent Application Publication
(10) Pub. No.: US 2001/0042081 A1
(43) Pub. Date: Nov. 15, 2001

(54) MARKUP LANGUAGE PARING FOR DOCUMENTS

(76) Inventors: IAN ALEXANDER MACFARLANE, ONTARIO (CA); A. JULIAN CRADDOCK, ONTARIO (CA); STEVEN M. ARMSTRONG, ONTARIO (CA); RAMZAN A. KHUWAJA, ONTARIO (CA)

Correspondence Address: GOWLING, LAFLEUR & HENDERSON LLP, 160 ELGIN STREET, SUITE 2600, OTTAWA, ON, K1P 1C3, CA

(21) Appl. No.: 08/994,452

(22) Filed: Dec. 19, 1997

(51) Int. Cl. G06F 15/00

(52) U.S. Cl. 707/513

(57) ABSTRACT

A method of paring a document, marked up using a given markup language before use of the document by an application such as a web browser, the document comprising markup and data, by identifying markup which is not used by the application; and creating a pared document using the same markup language, comprising other portions of the markup other than the identified portion. By tailoring the document to the application, the time that is required to download the document can be reduced, which is useful for users who are using slow links such as a connection through a cellular phone, and where the users device has limited display capabilities, meaning that much of the document cannot be used by the users application.

### BACKGROUND OF THE INVENTION

1. Field of the Invention

The invention relates to methods of paring a document, marked up using a given markup language before use of the document by an application, to methods of retrieving a document marked up using a given markup language, for use in an application of a given type, to apparatus for such methods and to software for such methods and apparatus.

2. Background Art

Markup languages are used to represent information in documents in a way which separates logical elements of the document, from data. In other words, the logical elements, called markup, provide meta information, i.e. information of a higher order about the content.

“Markup is text that is added to the data of a document in order to convey information about it. In generalized markup, the term ‘document’ does not refer to a physical construct such as a file or a set of printed pages. Instead, a document is a logical construct that contains a document element, the top node of a tree of elements that make up the document's content.”

The SGML handbook. Charles F. Goldfarb. ISBN 0 19 853737 9, 1990

Usually the document is character-based, and non text data such as images or audio files can be included by reference, by means such as a URL (uniform resource locator). The markup may be in the form of tags. A common example of a markup language is HTML (Hyper Text Markup Language). There is a standard for describing markup languages, SGML (Standard Generalised Markup Language).

In effect, HTML can be seen as a collection of platform-independent styles (indicated by tags), which set out the various components of a World Wide Web document. Any HTML document contains basic tags indicating a head part of the document, and a body part. The head includes tags such as the title. The body includes the data such as most of the content of the document. Elements of the data, such as each heading, table, hypertext link, etc, is delimited by tags, indicating the start and finish of the element to be processed according to the type of tag. A start tag comprises a pair of angle brackets enclosing a tag name. An end tag additionally includes a slash character before the tag name, or may be implied by the start of a new tag.

The popularity of HTML arises partly from its hypertext linking ability, to enable automatic access to other documents and other information in a wide variety of formats, and partly from its device independent nature. However, the latter results in users wishing to access HTML documents from applications with widely differing capabilities, and such applications may not make use of all the markup in the document, or all the data. An example is web browser programs which display the data in a manner governed by the tags, and enable user input. Different devices have widely differing display capabilities, and may have differing input capabilities.

If a browser processes an HTML document to display it, and reaches a tag which is inconsistent with its display capabilities, or is not recognised in the browser's implementation, it may simply ignore the markup and display the content according to a default style, or may not display the data. This may cause the content to be displayed in a manner undesired by the designer of the document. This is particularly likely for devices for mobile users to access the internet, where cost, size, and battery consumption limit the type of display hardware, and restrict its size, resolution, and color or greyscale handling. Also, these limitations can also restrict the size of the application, resulting in less functionality being included in versions of the browser targeted for such devices. This makes it more likely that more markup will be unsupported. Some web browsers discard information and markup if they do not support the markup but the information still has to be delivered to the browser before it can be discarded.

A number of device manufacturers have published HTML design guides (such as the one that describes how to best design web pages for access from a Nokia 9000 Communicator). These guides recommend restrictions on the markup that are used in the web page. This is an expensive proposition for content authors since duplicate web pages must be created to handle the multitude of devices. Furthermore, mechanisms would have to be provided to enable the correct, or the most suitable page version to be sent according to the type of device. It would be difficult, if not impractical, for content authors to be kept aware of the many different types of browsers which might access their web pages, and the different capabilities of the browsers. It would also be difficult to keep providing new versions of web pages as new browsers appear for new types of device devices.

Nobody has yet realised or addressed the problem that much unnecessary information is transmitted when documents are sent to applications which can or will use only a proportion of the information.

Automatic customisation of mark-up documents for specific browsers has been tried. There are many translators that convert HTML documents either from or to other formats, but these do not modify the HTML markup. Omnimark (TM) has a product that can serve HTML translations from SGML originals, but it only works for content providers that have the product as an integral part of their web. It does not address the problems in accessing random web pages on the world wide web, and does not modify HTML markup.

Text compression is ineffective for HTML documents since it requires that the original HTML document be compressed and that an application on the receiving device perform the decompression necessary to reconstruct the original document. HTML documents are typically not compressed.

The large majority of web pages on both the internet and intranets have been designed for display on powerful machines connected over high bandwidth networks. Significant portions of the markup and content in the HTML documents cannot be used by less capable applications such as browsers for simpler device devices, yet this information is still transmitted to the device on which the browser is running.

### SUMMARY OF THE INVENTION

It is an object of the invention to provide improved methods and apparatus.

According to the invention, there is provided a method of paring a document, marked up using a given markup language before use of the document by an application, the document comprising markup and data, the method comprising the steps of:

identifying a portion of the markup which is not used by the application; and

creating a pared document using the same markup language, and comprising other portions of the markup other than the identified portion.

This invention causes the document to be reduced in size before delivery to the application. An advantage is that the transmittal or storage of unused information can be avoided. This can reduce the time that is required to download the information. This is especially beneficial for users who are using slow links such as as a connection through a cellular phone. A document that did not contain this unused information would be smaller and thus take less time to transmit, and less space to store, without affecting the content which the application needs. None of the above prior art suggests paring automatically pre-existing documents for specific browsers or devices before an application uses the documents.

This invention provides a way to separate dynamically the issues related to tailoring for specific devices and browsers from the authoring process. Authors need no longer provide for specific applications at the outset. It could enable service providers to differentiate themselves by providing faster delivery of content to their customers which could improve response time and reduce the cost of using the service, particularly where data transmission is charged for, e.g. when using cellular telephone links.

Preferably, the markup language used is HTML. This popular mark up language is widely used for documents accessible to a large variety of different applications. Its hypertext linking ability, to enable automatic access to other information sources, such as audio, video, images, or text, and its device independent nature make it particularly useful. The latter makes the advantages of the invention particularly applicable.

Preferably, the markup language used is XML ( extensible Markup Language). This mark up language is being used for a wide variety of applications. Its linking ability, to enable automatic access to other documents or images, its extensibility, its structure and its ability to be validated, give it significant advantages over HTML. The likelihood of XML documents containing markup that is not required by an application, is intrinsically higher, owing to the characteristics of XML. This makes the advantages of the invention particularly applicable.

Preferably, the method further comprises the step of transmitting the pared document to a storage location where it can be processed by the application. The advantages are particularly notable where transmission is needed before processing by the application.

Preferably, the portions of the document used to create the pared document are chosen additionally on the basis of the characteristics of a path over which it is transmitted. An advantage is that this enables amongst other things that large amounts of data or large files may be downloaded only if the transmission path has a large enough bandwidth. Delays when transmitting across narrow bandwidth transmission paths can nevertheless be reduced.

Preferably, the application comprises a web browser. Such programs are widely used and already exist in many different types to suit devices of different capabilities.

Preferably, the identified portion not used, comprises white space characters which are not syntactically significant in the given language. Such characters are commonly used to improve readability by the author, but may be ignored by the application program, so it is advantageous to remove at least some of them before the document reaches the application program.

Preferably, the identified portion not used, comprises markup comments. Such characters are commonly used to improve readability, but may be ignored by the application program, so it may be advantageous to remove them before the document reaches the application program.

Preferably, the identified portion not used, comprises a meta tag. Such tags contain information about the document, e.g. properties, and may be ignored by the application program, so it is advantageous to remove them before the document reaches the application program. HTML includes such a tag.

Preferably, the pared document contains portions of the data other than a portion of the data relating to the identified portion of the markup. For markup which is removed, related data may be ignored by the application, in which case, it is advantageous to remove it before the document reaches the application program.

Preferably, the step of identifying a portion of the markup which is not used by the application, is carried out according to the type of the application. As the types of markup which are supported will vary according to the type of application, it may be possible to remove more markup, if the removal is tailored to the type of application.

Preferably, where the type of application is one which does not support a particular manner of presentation, the portion of the markup which is not used by the application comprises a portion of the markup relating to the unsupported manner of presentation. Display capabilities of devices may vary greatly with respect to style attributes, and so, there can be correspondingly great benefits in removing unused ones of such style attribute markup.

Preferably, the step of identifying a portion of the markup which is not used by the application, is carried out according to physical characteristics of a device used by a user when running the application. An advantage of this is that physical characteristics of the device may limit what markup and data can be used, thus enabling more to be pared from the document.

Preferably, the steps of identifying and removing the portion of the markup which is not used by the application are carried out by a proxy server. An advantage of this is that it enables documents from multiple servers to be pared without needing to provide a paring process on every one of the multiple servers. It may be impossible to put a paring process on such servers if for example they are controlled by a different user, e.g. a different company. It also enables easier maintenance and updating if the paring utility need only be installed in one place. Separating the processing of the paring from other processing activities at the server or at the user's terminal, by providing the proxy server, also enables the provision of suitable processing power for the paring without affecting or delaying the retrieval of documents by other applications not needing such paring.

Preferably, the steps of identifying and removing the portion of the markup which is not used by the application are carried out when the application requests the document. An advantage which arises is that storage requirements for pared documents can be reduced. This may be particularly useful where there are many such documents, and perhaps many different applications using different paring methods.

Preferably, the steps of identifying and removing the portion of the markup which is not used by the application are carried out before the application requests the document. This can enable response time to be improved, and reduce processing requirements, though at the expense of having to provide storage space for the pared documents, for example in a cache.

According to other aspects of the invention there is provided a method of retrieving a document, apparatus for retrieving a document, apparatus for paring a document, software for paring a document, and software for retrieving a document.

Any of the preferred features may be combined, and combined with any aspect of the invention, as would be apparent to a person skilled in the art.

To show, by way of example, how to put the invention into practice, embodiments will now be described in more detail, with reference to the accompanying drawings.

### BRIEF DESCRIPTION OF THE DRAWINGS

FIG. 1 shows a prior art arrangement;

FIG. 2 shows a prior art arrangement;

FIG. 3 shows an arrangement of devices, servers and software processes according to an embodiment of the invention;

FIG. 4 shows the mark-up paring process of FIGS. 3 in schematic form;

FIG. 5 shows a more detailed schematic of removing markup and data;

FIG. 6 shows a more detailed schematic view of determining whether markup can be discarded;

FIG. 7 shows the overall structure of alternative embodiment of the invention;

FIG. 8 shows the overall structure of alternative embodiment of the invention; and

FIG. 9 shows the overall structure of alternative embodiment of the invention.

### DETAILED DESCRIPTION

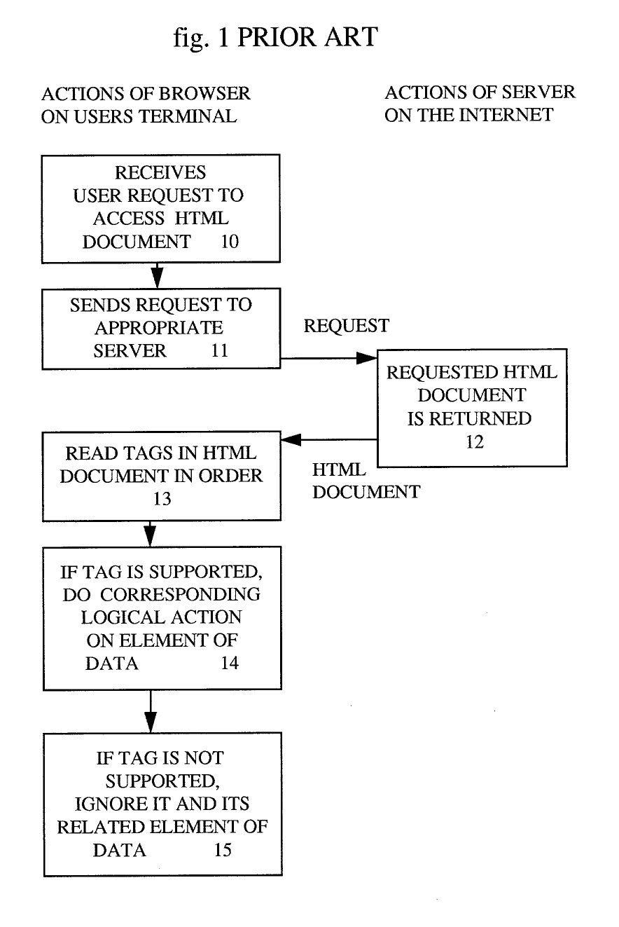

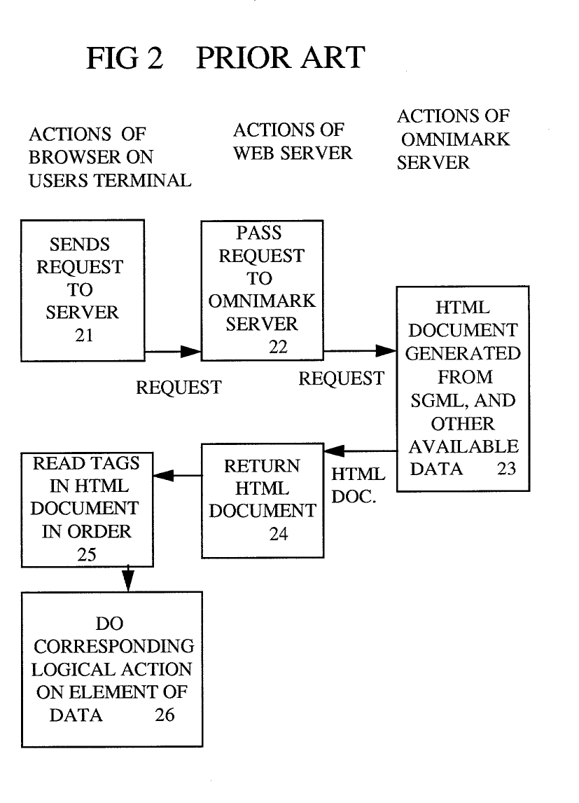

### FIGS. 1, 2: Prior Art

FIG. 1 shows in schematic form the functions carried out conventionally when a user accesses a document stored on a server on the internet. The user is running an application such as a web browser, on a device. The browser detects a user input requesting the document, at step 10. This will include a URL indicating the location of the document. The browser forwards the request to the appropriate server at step 11. There may be many transmission links and servers traversed by the request to reach the desired server (not shown). At step 12, the requested document is returned by the desired server to the browser. At 13, the browser reads the HTML document, and interprets markup and data as it comes to it. At 14, it determines if the markup is supported, and carries out the action required, for each element of the data in the document. Otherwise, as illustrated at 15, if the markup is not supported, it is ignored, and any data associated with the markup may also be ignored. Likewise, any characters outside the markup, such as space, or other syntactically insignificant characters are also ignored.

FIG. 2 shows in schematic form the functions of a more complex known arrangement. When a user sends a request from their device, using a web browser, at 21, the server addressed in the URL of the request passes the request on at 22, to another server. This other server is an OmniMark (TM) server, which effectively extends the function of the first server. It may be connected to the first server by a TCP/IP (Transmission Control Protocol/Internet Protocol) link, below a CGI (Common Gateway Interface) application.

The OmniMark server is programmed to generate the requested HTML document on receiving the request at step 23. It may convert data from various sources, including SGML documents, text and image files. This enables the content to be varied according to the type of user, and enables up to date data to be included. The generated HTML document, which can include hypertext links, is returned to the first server, which returns it at 24, to the users browser. At 25, and 26, the document is used by the browser, as described with reference to figure 1.

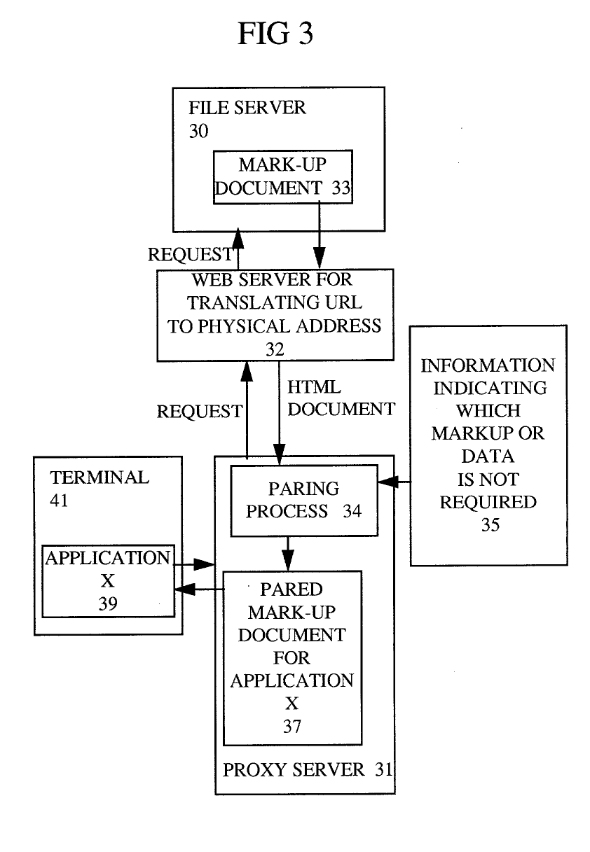

### FIG. 3 Overall Structure of an Embodiment of the Invention

In FIG. 3, an embodiment of the invention is shown in schematic form. A server 30 stores pregenerated documents 33 marked up using the given language, e.g. HTML. A web server 32 is provided for converting URLs of requests, to physical addresses where the documents reside. A markup paring process 34 for reducing the size of the document by removing some of the markup at least, is shown on a proxy server 31. Access requests are sent by way of the proxy server 31 to the web server from the users application 39, running on users devices 41, which may be connected to any point on the internet, and may be connected only intermittently. The pared HTML document 37 is returned to the users application.

The paring process could reside elsewhere, e.g. on the web server, or on the users device. The paring process may reference information stored elsewhere to determine how to pare the document, as shown by stored information 35, indicating which markup is not supported by particular types of applications or will have no effect on the device.

The type of application could be indicated in the request, either explicitly or implicitly, since the identity of the user can be in the request, so the type of application may be deduced from user information. This user information may be stored somewhere accessible to the paring process, e.g. on the same server, or on a different server. Such information could be coded into the paring process, but would be easier to maintain if stored separately. The paring process may also operate dependent on other information such as user preferences, or physical characteristics of the user device, or characteristics of the transmission path used in responding to the request. Many other such parameters, or combinations of parameters can be conceived by those skilled in the art, which can achieve similar effects.

The users' devices can be small portable devices with limited storage, processing and display capabilities. If they are mobile devices, connected to the internet by a wireless link such as a cellular network, or fixed access radio, the bandwidth of the link may be small and paid for according to the amount of data transmitted, or the duration of the connection. Accordingly, when markup files are accessed, if they can be pared, less storage is required, and processing will be quicker. If in addition, the paring takes place before transmission, then there will be less transmission cost and less transmission delay. The Nokia 9000 Communicator is an example of such a device, which is readily available, and need not be described in more detail here.

It is also envisaged that even simpler devices could be used, for example, legacy mobile phones with LCD text displays and GSM short message handling capability. An application running on a server could receive a request from a user from such a mobile phone using a short message. The application would take the response, e.g. an XML document, and request that it be sent back to the user as a short message. If a markup paring process is applied to the markup document before conversion to short messages, the transmission delay and transmission cost between the application and the user can be reduced. As there are millions of such mobile phones already in circulation, the possibility of enabling such a large group of users to access additional services is attractive. For example, information such as up to date stock prices, and up to date sports results, are already available on web pages. Particular information selected from the pages could be sent to the users mobile phone without the delay and expense of sending entire web pages, complete with images and other unwanted data.

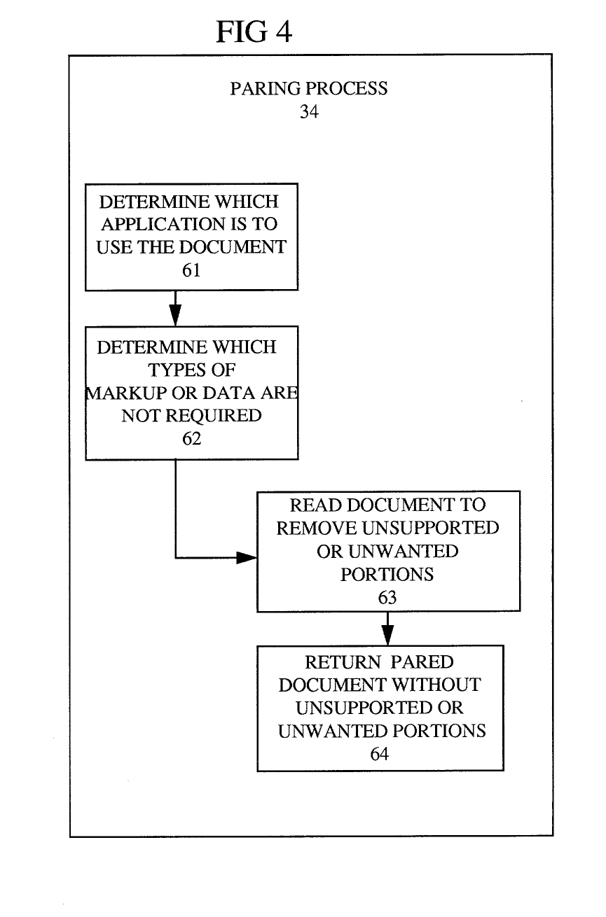

### FIG. 4 Overall Schematic of the Paring Process

FIG. 4 shows in schematic form the markup paring process 34 of FIG. 3. At step 61, it is determined which type of application is to use the pared document. This may be determined from information about the source of the request for the document, or may be explicit in the request. At 62, it is determined which markup is unsupported by the application. This may be carried out by accessing a database of information on such applications, which may be held on the same server, or held elsewhere. It may include information on whether meta tags, comments, images and so on are supported. The information on which markup is unsupported may be gathered when needed, or may be predetermined.

Additional information on markup to be removed according to factors such as user preferences, device characteristics, transmission link characteristics, can also be determined. This information is then used by the paring process as it goes through the markup in the document, removing markup and data at step 63. At step 64, the pared document without the unsupported and unwanted markup and data is returned.

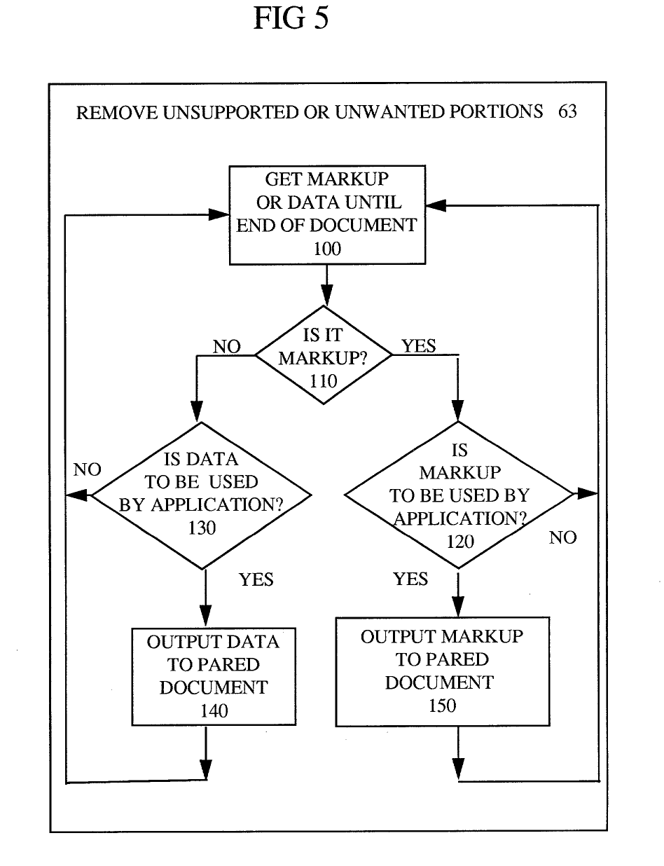

### FIG. 5—More Detailed Schematic of Removing Markup and Data

FIG. 5 shows the removal step 63 of FIG. 4 in more detail. At 100, a portion of markup or data in the document is read in. At 110, it is determined which of markup or data has been read in. If markup, at 120 it is determined whether it is markup which can be discarded, according to criteria established earlier. If not, the markup is added to the pared document at 150, without any characters such as whitespace, outside the markup, if it is syntactically insignificant, and the next portion is read in. If the markup portion can be discarded, step 150 is omitted.

If at step 110, the portion is identified as data, it is determined at 130 if the data is to be used by the application based upon its context within the document. If the data is not to be discarded, then at 140 it is added to the pared document.

Once all data and markup in the document have been processed, the pared document can be returned, as shown in step 64 of FIG. 4.

For example, a portion of an HTML document may contain the following markup and data:

<SCRIPT LANGUAGE=“JavaScript”>

function question (form, qsnbr, str){

form.q1.value=str

form.submit( )

}

</SCRIPT>

At step 100, the start tag for the SCRIPT tag will be obtained. At step 110, it is determined that the information is markup and goes to step 120. At step 120, it may be determined that the SCRIPT start tag is not used by the application (e.g. a browser does not support JavaScript). The paring process identifies that it is now processing a SCRIPT. The markup is not output to the pared document.

At step 100, the data (function definition) will be obtained and at 110, it is determined that it is not markup. At step 130, it is determined that the data is not used by the application since it is the body of the script. The markup is not output to the pared document. At 100 the end tag for the SCRIPT is obtained and is identified as markup at 110. At 120, it is determined that the markup is not used by the application. The compression process identifies that it is no longer processing a SCRIPT. The markup is not output to the pared document and processing continues at 100.

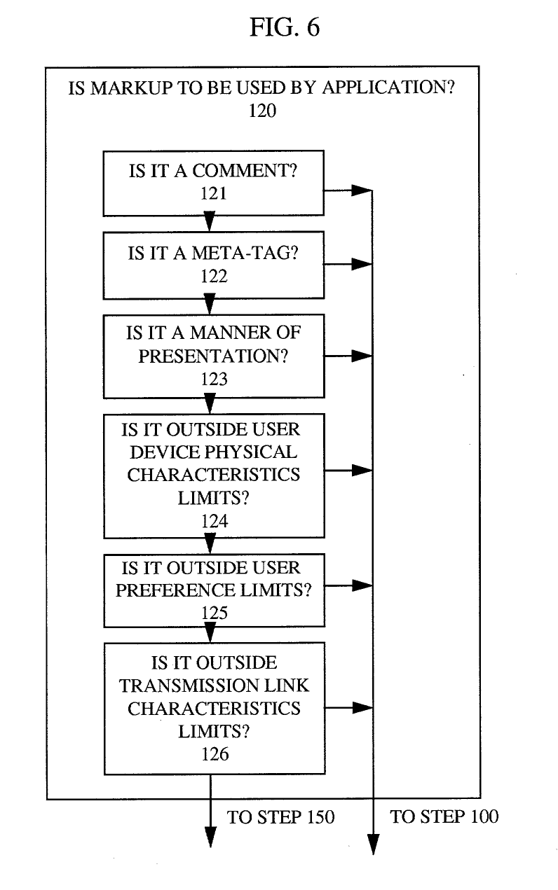

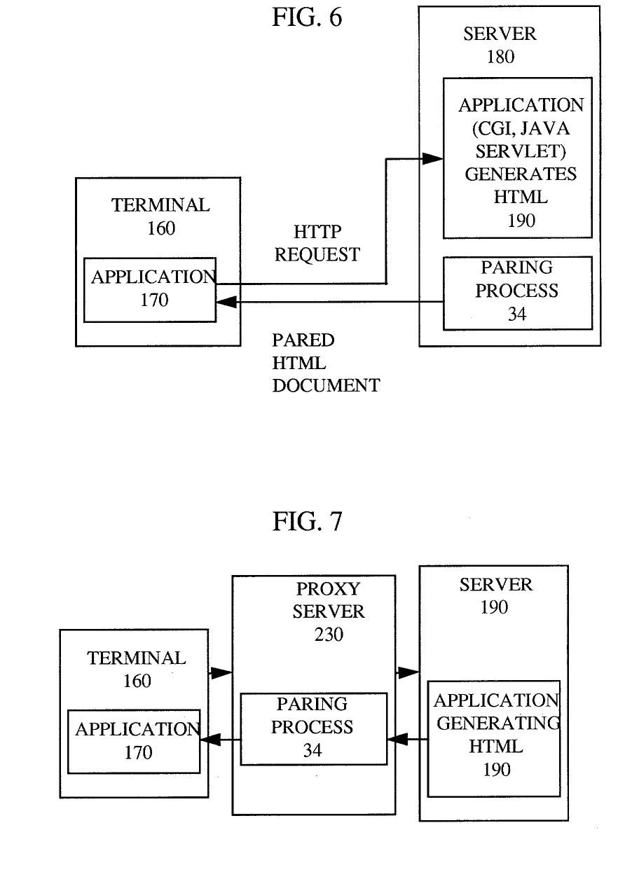

### FIG. 6—More Detailed Schematic of Determining Whether Markup can be Discarded

An example of the step 120 of determining whether the markup can be discarded or not is shown in more detail, schematically in FIG. 6. Depending on inputs indicating the type of application, which may include details of the physical characteristics of the user device, user preferences, transmission link characteristics, a set of tests tailored to each document access request can be assembled. In the example shown, At 121, it is determined if the markup is a comment. If not, it is determined at 122 if it is a meta tag. If not, it is determined at 123 if the markup relate to a particular manner of presentation not supported by the application.

If not, the markup is tested at 124 to see if they exceed given physical characteristics of the users device, beyond the limitations of the application, such as screen size, resolution, limited keyboard and so on. If they pass that test they are tested at 125 to see if any user preferences would cause the markup to be discarded, e.g. if the user wishes to see text only, or doesnt want to see any moving images, or receive any sound files, they could be discarded here. If that test is passed, a final test at 126 determines whether the a portion of the document might be so large as to delay transmission too long, considering the characteristics of the transmission links used to pass the pared document to the user.

If any of the tests are failed, and the markup is to be discarded, the process moves on to step 100 of FIG. 5. Otherwise, the markup being tested is added to the pared document in step 150 of FIG. 5.

There is no significance to the order of the tests in the example described above, though there may be benefits in terms of processing speed, in specifying a particular order, if some tests take longer than others. Various implementations will be apparent to those skilled in the art, and need not be described further here.

### Elimination of White Space

White space that is not syntactically significant can be reduced to a single space or even eliminated. Many pages use spaces for indentation to improve readability by the author/editor of the page. These extra spaces are not required for correct rendering of the HTML. Each extra space is a character which would otherwise be transmitted. Often there will be several characters of such indentation on most lines, so the additional amount of redundant information in the markup may be considerable. Either according to preference, or according to the type of application using the document, some whitespace may be left in the pared document. For example document size can be reduced by eliminating as much white space as possible. If some degree of readability is needed, the document size could still be reduced by removing all but a minimal amount of indentation.

### Elimination of Comments

Comments are typically helpful for people who are modifying code but not to the web browsers. Although CGIs (Common Gateway Interfaces) in the case of HTML documents, or other special processing can be initiated through comments, these can be processed by the server before they get to the paring process or can be left untouched by the paring process depending upon the needs of the application.

### Elimination of Meta Tags

Meta tags are used to define meta-information about the document, i.e. information of a higher order, such as properties of the document. A definition of the syntax of such tags in HTML is as follows:

<!ELEMENT META—ZERO EMPTY-Generic Meta-information —>

<!ATTLIST META

http-equiv NAME #IMPLIED—HTTP response header name—

name NAME #IMPLIED—meta-information name—

content CDATA #REQUIRED—associated information—

>

The META element can be used to include name/value pairs describing properties of the document, such as author, expiry date, a list of keywords etc. The NAME attribute specifies the property name while the CONTENT attribute specifies the property value, e.g.

<META NAME=“Author” CONTENT=“Dave Raggett”>

The HTTP-EQUIV attribute can be used in place of the NAME attribute and has a special significance when documents are retrieved via the Hypertext Transfer Protocol (HTTP). HTTP servers may use the property name specified by the HTTP-EQUIV attribute to create an RFC 822 style header in the HTTP response. This can't be used to set certain HTTP headers though, see the HTTP specification for details.

<META HTTP-EQUIV=“Refresh” CONTENT=“10;URL=www. company .com”>

<META HTTP-EQUIV=“Expires” CONTENT=“Tue, Aug. 20, 1996 14:25:27 GMT”>

will result in the HTTP header:

Expires: Tue, Aug. 20, 1996 14:25:27 GMT

This can be used by caches to determine when to fetch a fresh copy of the associated document.

Such information is sometimes not required by an application, or cannot be processed, and can therefore be removed by the paring process.

### Elimination of Markup that are Either not Supported by the Device or Would Reduce the Usability of the Rendered Page

Many of the attributes of HTML markup is related to style: color, position, width, height, etc. On small devices and/or devices with restricted colors (grayscale), the size of the HTML document can be reduced by removing these attributes. Examples include removing attributes such as BACKGROUND, FOREGROUND, BGCOLOR, TEXT, VLINK, ALINK, LEFTMARGIN, TOPMARGIN, ALIGN, VALIGN, WIDTH, HEIGHT, CELLPADDING, etc. and removing FONT tag attributes such as COLOR, STYLE, etc.

### Dependency on Physical Characteristics

The determination of what to omit from the document can be made dependent on physical characteristics of the user device such as screen size, usually in terms of numbers of characters across the screen, and number of lines of characters. Other physical characteristics may include dimension of the display in terms of numbers of pixels across and down, color handling or greyscale capabilities in terms of bits per pixel, and sound reproduction capabilities.

Implementation of the dependence on physical characteristics can be either predetermined at the coding of the paring process, or can be at least partially data driven. In the latter case, for each document, information on appropriate physical characteristics would need to be provided to enable the paring to be tailored to suit. The tailoring could be carried out by selection of an appropriate process from many processes, or by branching in the process according to the physical characteristics. The information on appropriate physical characteristics could be provided by including it in or with the document access request from the user, if the format or protocol for the request permits this, or by maintaining a store of user preferences including the desired physical characteristics of the user's device. This could be maintained either locally on the server performing the paring, or elsewhere. This could be updated at the time of a user logging in to a service provider for example.

The tailoring to physical characteristics could encompass removing links to audio or multimedia output documents, if the user's device did not support such types of output. The tailoring could also encompass removing links to images which cannot be displayed for any reason, including them being too large for the display size, or to all images if the display is character-based.

### Link Dependency

The paring may be tailored to the type of link being used by a user to access the document. If it is a slow link such as a modem on a public service telephone line, the paring could be tailored to remove more markup and data than would be removed if a fast data link is being used. For example it could be tailored to ensure removal or replacement of inline links to documents above a certain size, which could delay transmission longer than a given threshold. The same user could access the document over different speed links, from home, mobile phone, or office network, and could do so using the same portable computer. Therefore, to tailor the paring to these links, additional information should be supplied, beyond the user device physical characteristics. This could be provided by including it in or with the document access request from the user, if the format or protocol for the request permits this, or by maintaining a store of the link characteristics used for each document access request, either locally on the server performing the paring, or elsewhere. The link characteristics could include the bandwidth, latency, quality of service parameters and so on.

### Implementation Considerations

The request for access to the document can specify the application if it is an HTTP (hypertext transfer protocol) request using the UserAgent header field. However, the protocol does not allow the device to be specified, so some sort of device registry would be required. This could be updated when a user logs on to a particular service provider, could be in a predetermined user profile, or could be imferred by the application. The transmission link characteristics could also be specified.

The paring process can be implemented using C, Java, AWK, or any language which can handle parsing and manipulation of text. The servers can be run on a variety of machines including any Windows™ or UNIX™ type workstation, an example being a Sun™ workstation running the Solaris™ 2.5 operating system. The design of such servers, and appropriate software for achieving communication with other servers, and orderly start up and shut down of connections, is well known and need not be described here in more detail.

Paring processes can be written for each browser/device that is to be supported. These processes can be invoked when an HTML document is requested: the proxy server can invoke the appropriate translator for the requesting device/browser to modify the markup before returning it to the requesting device. They can also be invoked as part of a document authoring process: an HTML document that has been created can be translated into multiple documents by one or more translators, including the paring process described above. The translated documents are then made available to the end user over the web.

The elimination of information that is not needed by the browser can reduce the size of the data that needs to be transmitted. Special treatment may be necessary to turn off the paring capability under user control since the user may be requesting the document to view or save the original source. If information is removed, it may affect the quality and usability of the requested document.

### FIG. 7—Overall Structure of Alternative Embodiment of the Invention

FIG. 7 shows an alternative structure in which a requested HTML document is generated on demand. A users device such as a device 160, has an application 170 which sends an HTTP request for a document to a server 180. Another application 190 implemented using a on the server responds to the request by generating an HTML document including predetermined data, according to the URL in the request. The resulting HTML document is then tailored to suit the application 170 using a paring process 200. The paring process may be similar to that described in more detail above. Different types of application can request the document, and the data and the paring can be tailored to suit.

### FIG. 8—Overall Structure of Alternative Embodiment of the Invention

FIG. 8 shows another alternative embodiment. In addition to the features shown in FIG. 7, a proxy server 230 is provided for running the paring process independently of the server provided for generating the HTML document. This can provide the advantages set out above in the summary of invention.

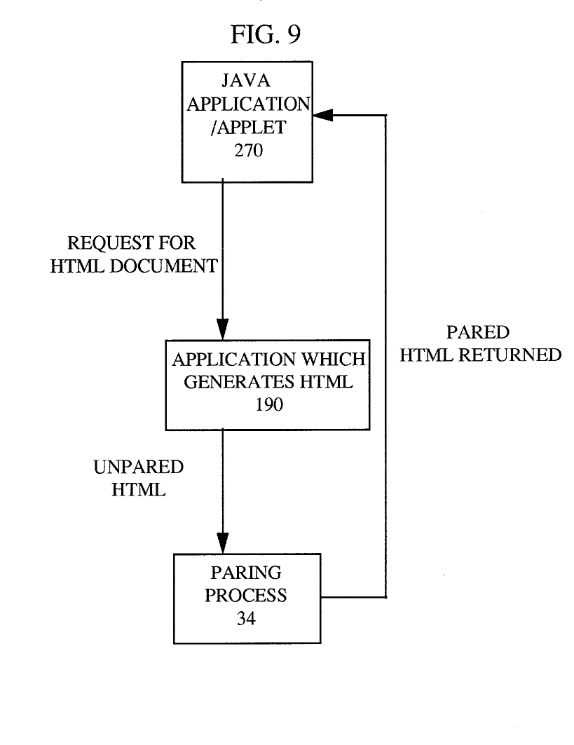

### FIG. 9—Overall Structure of Alternative Embodiment of the Invention

FIG. 9 shows an embodiment in which the elements shown in FIG. 7 are not necessarily located on different servers, and do not necessarily use HTTP or internet protocols for communication between servers. The application 270 requesting the document can be a Java application/applet.

### Other Variations

Although the examples described above use HTML, other mark up languages could be used, such as XML (extensible markup language), HDML (hand held device markup language) and TTML (tagged text markup language) and the advantages of the invention are clearly applicable to such languages.

### Other Fields of Application

Although the invention has been described with reference to web browser programs, clearly other applications could use the documents, and the benefits of the invention would still apply. For example, applications exist for accessing an HTML page to extract data for use by other programs. Stock prices for particular companies can be extracted from stock exchange HTML documents without displaying the pages. The extracted stock prices could then be assembled and combined with historic stock prices to establish trends. Such information might be assembled into another HTML page for access or display by a user. If the stock exchange documents could be accessed without downloading all the unwanted information on the page, access would be faster, and transmission costs might be reduced. Many other applications can be conceived.

Other variations as well as those discussed above will be apparent to persons of average skill in the art, within the scope of the claims, and are not intended to be excluded.

What is claimed is:

1. A method of paring a document, marked up using a given markup language before use of the document by an application, the document comprising markup and data, the method comprising the steps of:
identifying a portion of the markup which is not used by the application; and
creating a pared document using the same markup language, and comprising other portions of the markup other than the identified portion.

2. The method of claim 1 wherein the given markup language is HyperText Markup Language.

3. The method of claim 1 wherein the given markup language is eXtensible Markup Language.

4. The method of claim 1 further comprising the step of transmitting the pared document to a storage location where it can be processed by the application.

5. The method of claim 4 wherein the portions of the document used to create the pared document are chosen additionally on the basis of the characteristics of a path over which it is transmitted.

6. The method of claim 1 wherein the application comprises a web browser program.

7. The method of claim 1 wherein the identified portion not used, comprises white space characters which are not syntactically significant in the given language.

8. The method of claim 1 wherein the identified portion not used, comprises markup comments.

9. The method of claim 1 wherein the identified portion not used, comprises a meta tag.

10. The method of claim 1 wherein the pared document contains portions of the data other than a portion of the data relating to the identified portion of the markup.

11. The method of claim 1 wherein the step of identifying a portion of the markup which is not used by the application, is carried out according to the type of the application.

12. The method of claim 11 wherein the type of application is one which does not support a particular manner of presentation, and the portion of the markup which is not used by the application comprises a portion of the markup relating to the unsupported manner of presentation.

13. The method of claim 1 wherein the step of identifying a portion of the markup which is not used by the application, is carried out according to physical characteristics of a device used by a user when running the application.

14. The method of claim 1 wherein the steps of identifying and removing the portion of the markup which is not used by the application are carried out by a proxy server.

15. The method of claim 1 wherein the steps of identifying and removing the portion of the markup which is not used by the application are carried out when the application requests the document.

16. The method of claim 1 wherein the steps of identifying and removing the portion of the markup which is not used by the application are carried out before the application requests the document.

17. A method of retrieving a document marked up using a given markup language, for use in an application of a given type, the document comprising data and markup, the document being usable by a number of different types of application, the method comprising the steps of:
requesting access to the document; and
receiving a pared version of the document, using the same markup language, for use in the application of the given type, and comprising portions of the markup other than a portion identified as not being required by the application of the given type.

18. Apparatus for paring a document, before use of the document by an application, the document being marked up using a given markup language, and comprising markup and data, the apparatus comprising:
means for identifying a portion of the markup which is not used by the application; and
means for creating a pared document using the same markup language, and comprising other portions of the markup other than the identified portion.

19. Apparatus for paring a document, before use of the document by an application, the document being marked up using a given markup language, and comprising markup and data, the apparatus comprising:
apparatus arranged to identify a portion of the markup which is not used by the application; and
apparatus arranged to create a pared document using the same markup language, and comprising other portions of the markup other than the identified portion.

20. Apparatus for retrieving a document represented in a markup language, for use in an application of a given type, the document being marked up using a given markup language, and comprising data and markup, the document being usable by a number of different types of application, the apparatus comprising:
apparatus arranged to request access to the document; and
apparatus arranged to create a pared version of the document, in the same markup language, for use in the application of the given type, by identifying a portion of the markup which is not used by the application, the pared version of the document comprising portions of the markup other than a portion identified as not being required by the application of the given type.

21. Software stored on a machine-readable medium for carrying out a method of paring a document, before use of the document by an application, the document being marked up using a given markup language, and comprising markup and data, the method comprising the steps of:
identifying a portion of the markup which is not used by the application; and
creating a pared document in the same markup language, and comprising other portions of the markup other than the identified portion.

22. Software stored on a machine-readable medium for carrying out a method of retrieving a document, for use in an application of a given type, the document comprising information which comprises data and markup, the document being usable by a number of different types of application, the method comprising the steps of:
requesting access to the document; and
creating a pared version of the document, for use in the application of the given type, by identifying a portion of the markup which is not used by the application, the pared document comprising portions of the markup other than a portion identified as not being required by the application of the given type.
